(19) United States
(12) Patent Application Publication
(10) Pub. No.: US 2014/0031086 A1
(43) Pub. Date: Jan. 30, 2014

(54) System of servicing famous people's characters in smart phone and operation method thereof

(71) Applicant: Tae Ho Yoo, Diamond Bar, CA (US)

(72) Inventor: Tae Ho Yoo, Diamond Bar, CA (US)

(21) Appl. No.: 13/911,043

(22) Filed: Jun. 5, 2013

(30) Foreign Application Priority Data
Jun. 5, 2012 (KR) 10-2012-0060168

(51) Int. Cl. H04M 1/725

(52) U.S. Cl. CPC H04M 1/72519
USPC 455/566

(57) ABSTRACT

Provided is a system of servicing famous people's character in smart phone and method for managing it, which image-processes the picture images of famous people such as singer, actor, sports player, celebrity, etc. who are registered in a server into characters and stores them, downloads them on the smart phone, makes the displayed character acts variously through stimulating them with screen touch, etc. of the smart phone, and enjoys or learns the song, new issue of songs, dance, exercise, lecture, etc. in multimedia, and it is possible to enjoy various genre's contents of a favorite celebrity through the properties including the smart phone, the communication network, and a character server, and to get taught by the favorite famous person, and the user can obtain an emotional stability by exchanging emotions with the character of the favorite famous person, and manages his or her own schedule.

### BACKGROUND

The invention relates to a system of servicing character and operating method thereof using smart phone, more specifically to a system of servicing famous people's character in smart phone and operating method thereof, in which picture images with famous people such as singer, actor, sports star, celebrity, etc. who are registered on a server, as main subjects are image-processed and stored as characters, the characters downloaded to and displayed in the smart phone are stimulated using screen touch and the like so as to be behaved in various ways, and their activities such as song, launching of new song, dance, exercise, lecture, etc. that are outputted along with the characters are enjoyed or learned as multimedia contents.

And the invention relates to a system of servicing character and operating method thereof using smart phone, which performs a fan group activities centered around the main subjects of the character displayed on the smart phone, exchanges information, fan letter, gift, etc., and manages schedule of the user.

A portable terminal for mobile communication is a terminal, which has a state-of-art technology for accessing and communicating with a desired target person instantly anywhere any time while moving around freely inside a service area formed by the mobile communication system.

Communication is for transmitting or verifying urgent news or message to assigned target fast and precisely, and it can take place any time and anywhere but it may be needed for a very short time a day and on some days no need at all.

The mobile communication terminal was developed to satisfy such characteristics of communication as a light-thin-short-small form for responding to the need occurring any time anywhere, and therefore it is convenient to carry around in general.

The mobile communication terminal that is carried always for unpredictable and sporadic needs has a very low usage, and in order to increase the usage the additional functions have been added, including, for example, MP3, game, TV, camera, texting, recording, etc., and it evolves in a direction for satisfying five senses of human using vibration and the like, enabling multimedia communication using the functions of camera, widened video display, and upgraded audio.

By including functions of wireless LAN and computer, the mobile communication terminal has been evolved into a palm-computerized smart phone, such that the capacity of processing digital data signals is increased drastically and various Apps are added, widening the usage (applications) further.

Avatar or character is a graphic icon representing an object, animal, person, etc. selected in a virtual space such as computer, Internet, mobile communication terminal, etc. as a 2-dimensional picture or a 3-dimensional virtual person, which moves, grows, has emotion and thought like a human under specific conditions, and can be made to respond to given situations for itself.

A prior art, a Korean Patent Application No. 10-2004-0056489 (2004.7.20) “Artificial Intelligence Avatar System and Mobile communication terminal having such Avatar function”, provides an avatar related to everyday life using mobile communication terminal.

FIG. 1 is a schematic block diagram showing an avatar system according to an embodiment of a prior art.

Below, referring to the figures, it includes a memory portion (16), a data input portion (171), a biorhythm calculation portion (172), an avatar data selection processing portion (173), an avatar conversion processing portion (174), and an avatar output portion (14).

The above art describes an artificial intelligence avatar and a method for changing itself according to the degree of growth of the user according to the indirect emotion state of the user.

However, the prior art can show how the avatar changes itself according to the emotional state and degree of growth of the user, but it has limits of being unable to enjoy the activities such as song, launching of new song, dance, exercise, lecture, etc. through the characters of singer, actor/actress, celebrity, sports star, etc. whom the user likes, by multimedia.

On the other hand, songs, dance, habits (behaviors), lecture, sermon, etc. of famous people such as singer, talent (actor/actress), celebrity, sports person, specialist, popular person, etc. whom people like according to recent international trends of Korean styles and K-pop have been enjoyed or imitated or learned by the people, which makes needs to develop technology using smart phone.

### SUMMARY OF THE INVENTION

The invention for solving the above problems of the prior arts provides a system of servicing character and operating method thereof using smart phone, which registers pictures of famous people on a character server, image-processes the registered pictures of the famous people into characters, downloads them to a smart phone, and decorates the characters with clothes or accessories for character.

The invention provides a system of servicing character and operating method thereof using smart phone, which makes a character in the smart phone move to corresponding states by applying various stimulation to the character so as to cause interests and attentions to a user, and makes the user exchange emotions with the character.

The invention provides a system of servicing character and operating method thereof using smart phone, which enables speedy using of the character services because the character in the smart phone is image-processed to a small size and displayed all the time whenever the screen or the menu of the smart phone changes.

The invention provides a system of servicing character and operating method thereof using smart phone, which enables to access the character server using the character displayed in the smart phone, search for contents on the character person's activities or pronouncements, and enjoy or learn them with the multimedia contents.

The invention provides a system of servicing character and operating method thereof using smart phone, which enables to organize or attend a fandom group or club using the character in the smart phone, deliver fan letters, gifts, information, etc. to the character person, or exchange them among the fandom.

The invention provides a system of servicing character and operating method thereof using smart phone, which enables to manage a schedule set by the user using the character downloaded to the smart phone from the character server.

A system of servicing character and operating method thereof using smart phone for solving the above problems registers famous people to a character server according to predetermined procedures, image-processes the picture images of the registered famous people into characters of various images, and store-and-manages in an assigned database.

The various images of the character includes emotional expressions such as laughing, weeping, astonishing, suffering, etc., art activities such as singing, playing, performing, dancing, etc., sports activities such as golf, soccer, swimming, etc., and everyday life activities, and more other activities of different genre can be further included if necessary.

The various images of the character can be processed with well-known arts of taking pictures 2-dimensionally or 3-dimensionally and image-processing, and they can be stored and provided as multimedia contents.

If a character service menu is selected, the smart phone accesses the character server and searches, and if a specific famous person is selected and clicked, the smart phone downloads characters that are image-processed in various forms and actions from the character server for free or for a fee.

The smart phone, if stimulation such as shaking, startling, tickling, making sing, making dance, etc. is applied from outside, can image-process and display the character according to the stimulation.

In an embodiment, if the character displayed in the smart phone is tickled, the character is image-processed and displayed in a laughing form, and if startled, the character is image-processed and displayed in a startled form, such that the user can have all the feelings as if he/she exchanges emotions directly with the specific famous person of their choice.

Even though the screen or menu of the smart phone is changed, the smart phone can image-process and display the character in a smaller size always on the changed screen or menu.

The smart phone can inform a schedule that is set by the assigned character person.

The smart phone can make the emotional satisfaction of the user of being with the chosen famous person all the time increased much by making an environment for exchanging emotions with the character person through the character directly or indirectly through sending fan letters and gifts to the character person, performing activities related to a fan club or fandom group for the character, etc.

The smart phone may be used to access a character server through the character displayed on the smart phone, search for the activities of the character person, and download as or watch multimedia contents.

The contents in forms of multimedia including video, audio, and text, may be provided for a given fee or for free, produced directly or indirectly by the character person, and include all kinds of genre such as songs including new song and favorite song, dance, performance, golf, soccer, swimming, everyday life, etc.

The smart phone may prepare various clothes, accessories, etc. for the character, decorate the stored character according to the user's taste, and if the character talks or sings, a balloon for talk may be selected.

The character server, if getting lessons (lectures, studies), can combine the selected character and the lesson contents, and image-process and provide as if the character teaches.

Such lesson contents may include all kinds of genre, prepared in multimedia, stored in the character server, and the selected lesson contents can be provided to the smart phone upon searching.

The smart phone can access the character server, watch in real-time the multimedia contents that the character person issued or is issuing presently, and search and verify news that is produced or collected around the character person.

The character person may include a singer, a talent, an actor/actress, a sports star, an artist, an entrepreneur, a religious person, a politician, a composer, a novelist, a professor, a farmer, a fisherman, an engineer, a craftsman, an individual, a legal person, etc.

The invention as in the above enables the user to download a character of a famous person registered on the character server to a smart phone, decorate the character with clothes, accessories, etc. for character prepared separately, and enjoy all the procedures as hobby.

The invention enables the user to apply various types of stimulation to the character displayed on the smart phone, enjoy the character's moving or behaving correspondingly to the stimulation, and achieve feelings of emotional stability and satisfaction that he or she is with the character person all the time and anywhere.

The smart phone of the invention enables the user to use the services through the character fast because when the present menu or screen is changed by the user, the displayed character is image-processed into a smaller size and displayed all the time.

The invention enables the user to access the character server through the character displayed on the smart phone, search the contents that the character person performed or issued, and watch or learn them in multimedia anytime anywhere.

The smart phone of the invention enables the user to be interested in and more concentrated on the education because the learning process is conducted by the character of the famous person who the user likes.

The smart phone of the invention enables the user to access the character server using the character, form or attend a fan club (fandom group) for the character person, deliver fan letters, gifts, information, etc. to the character person, and exchange them among the members of the fan club.

The smart phone of the invention enables the user to manage the schedule because the user manage using the schedule set by the user and the character that the user selected and downloaded.

### BRIEF DESCRIPTION OF DRAWINGS

FIG. 1 is a function diagram of an avatar service system using a mobile communication terminal according to an embodiment of prior arts;

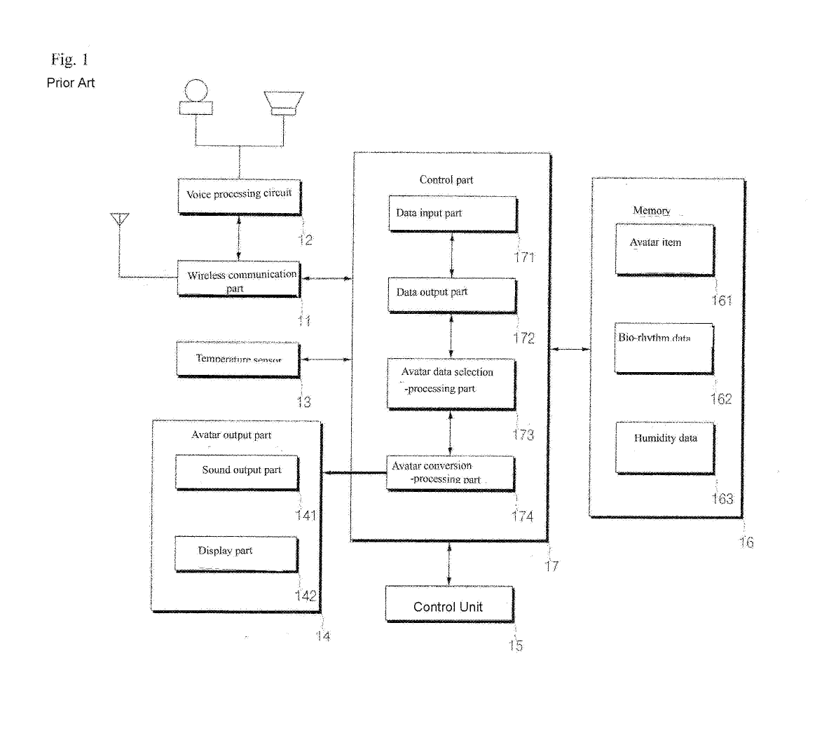

FIG. 2 is a function diagram of a famous people's character service system using a smart phone according to an embodiment of the invention;

FIG. 3 is a detailed function diagram of a character server according to an embodiment of the invention;

FIG. 4 is a function diagram of a smart phone according to an embodiment of the invention;

FIG. 5 is a flow chart of a method for managing of a character server according to an embodiment of the invention; and

FIGS. 6 and 7 are flow charts of a method for managing of a smart phone according to an embodiment of the invention.

### DETAILED DESCRIPTION OF THE INVENTION

Since the invention can be changed variously and have many embodiments, specific embodiments have been shown in the drawings and are going to be described in detail below. However, they are not going to limit the invention to certain embodiments, and all the changes, equivalents, or replacements that are included in the spirit and technology of the invention must be understood to be included in the invention. In describing the invention, detailed explanations on prior arts may be omitted if decided to blur understanding of the invention.

Below, the avatar and the character are used for a same meaning, and the character person may include a singer, a talent, an actor/actress, a sports star, an artist, an entrepreneur, a religious person, a politician, a composer, a novelist, a professor, a farmer, a fisherman, an engineer, a craftsman, an individual, a legal person, etc.

All the genres of multimedia contents that produced or issued by the character person may include song, newly issued song, gag, dance, play, movie, drama, vocal, speech, lecture, golf, soccer, ballet, performance, concert, competition, exhibition, etc., and the multimedia contents is understood to include more than any one of all the media including audio, video, and text.

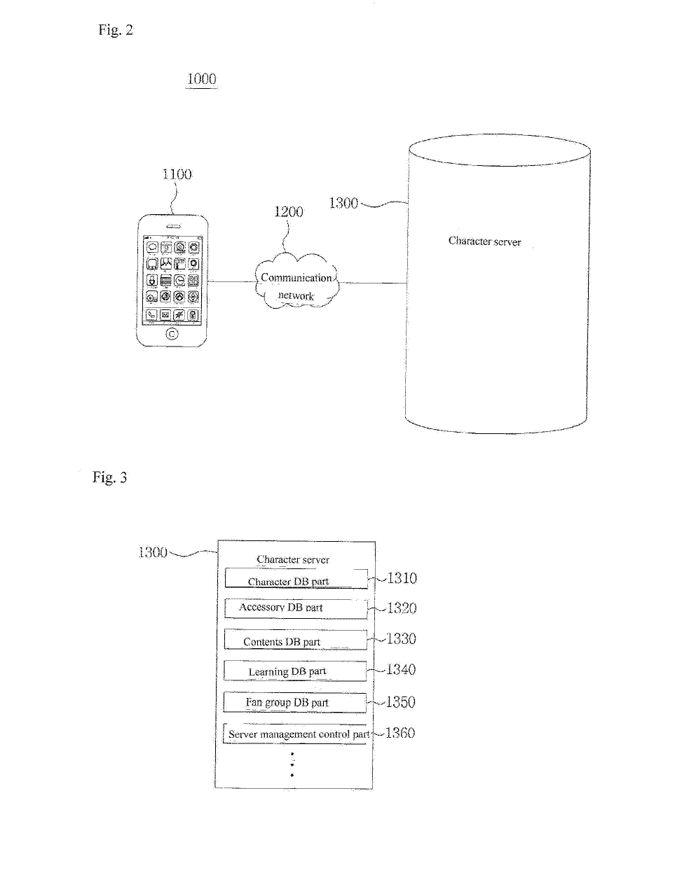

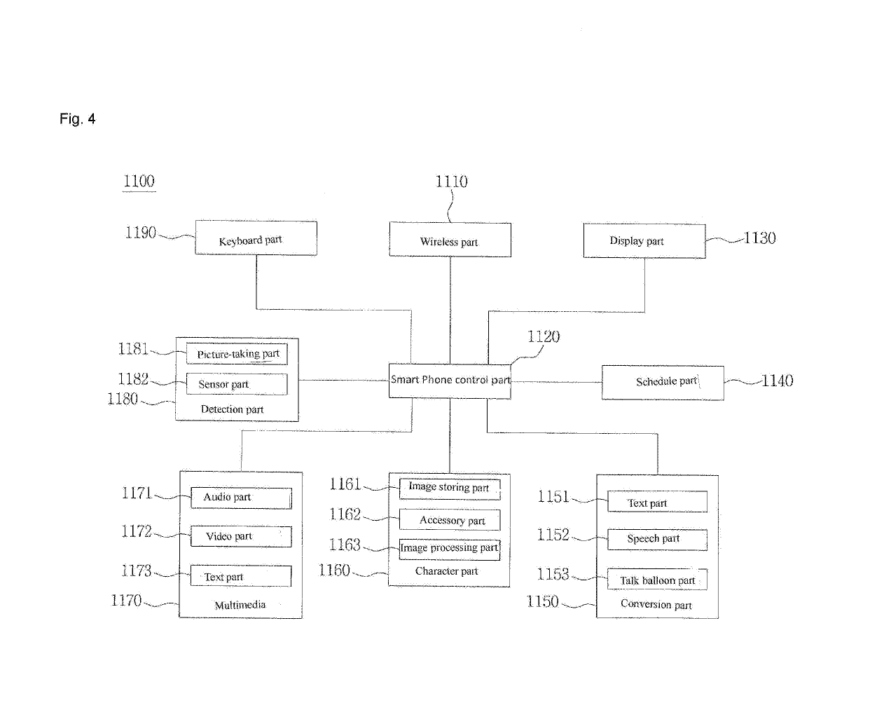

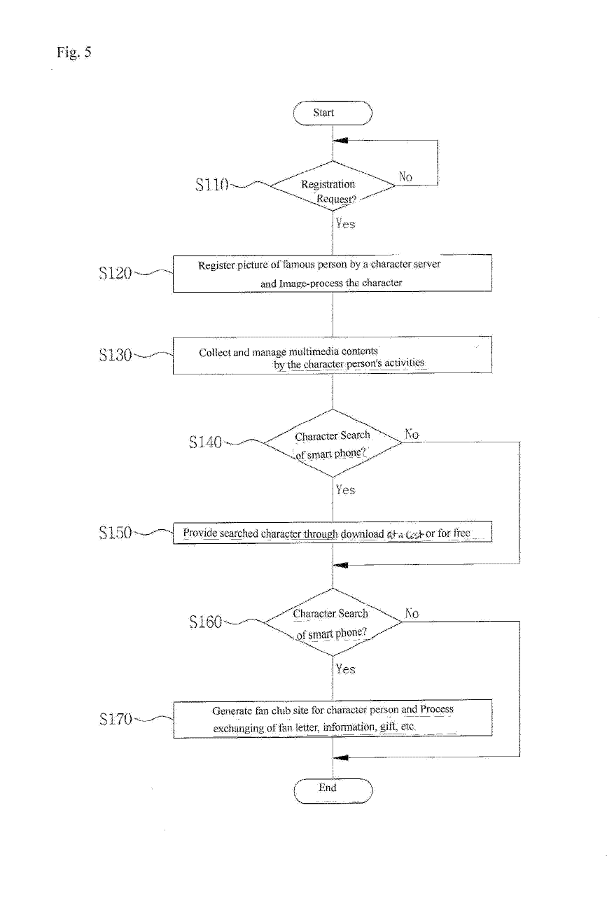

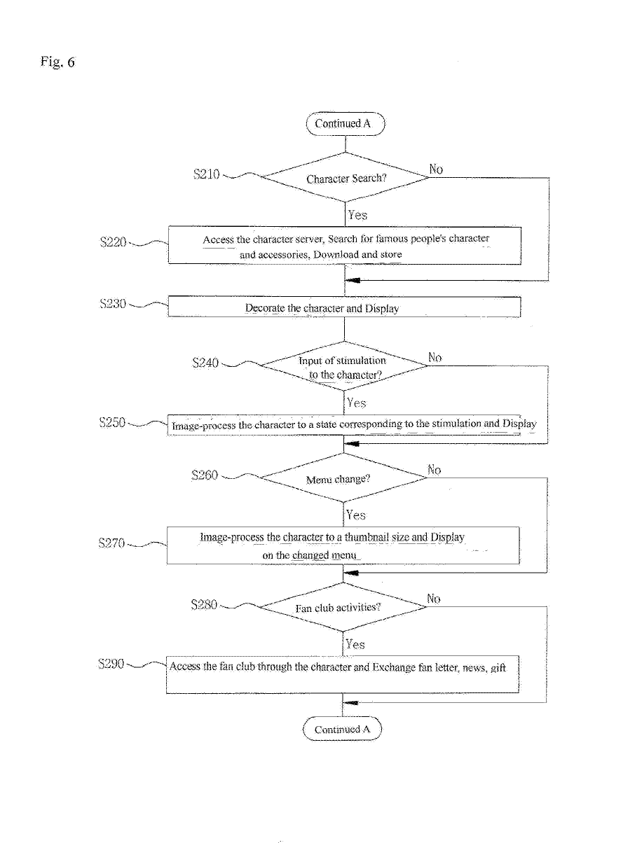

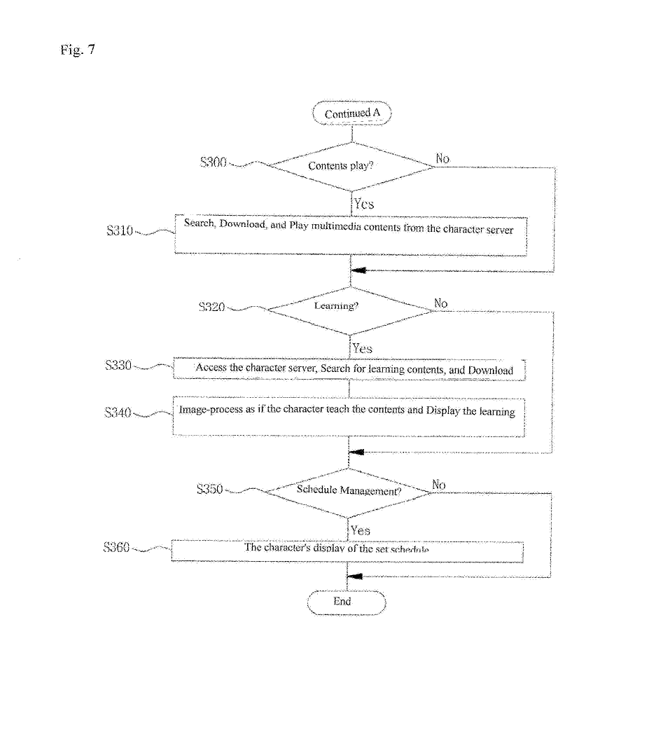

FIG. 2 is a function diagram of a famous people's character service system using a smart phone according to an embodiment of the invention, FIG. 3 is a detailed function diagram of a character server according to an embodiment of the invention, FIG. 4 is a function diagram of a smart phone according to an embodiment of the invention, FIG. 5 is a flow chart of a method for managing of a character server according to an embodiment of the invention, and FIGS. 6 and 7 are flow charts of a method for managing of a smart phone according to an embodiment of the invention.

Below, describing in detail referring to the drawings, a system of servicing famous people's character in smart phone (1000) includes a smart phone (1100), a communication network (1200), and a character server (1300).

The smart phone (1100) accesses or log-on to the character server (1300), searches a character generated from face shapes, entire body shapes, characteristic movements, etc. and registered by the famous person, downloads the character of the user's favorite famous person for a fee or for free, and decorates the character with various accessories.

The accessories may be 2-dimensional or 3-dimensional, which may be very various like cloth, glasses, hat, watch, ring, sports equipment, bicycle, automobile, etc., and they can be searched in the character server (1300), and downloaded for a fee or for free.

The smart phone (1100) may include a wireless part (1110), a smart phone control part (1120), a display part (1130), a schedule part (1140), a conversion part (1150), a character part (1160), a multimedia part (1170), a detection part (1180), and a keyboard part (1190).

The smart phone (1100) is manufactured, on the market, and circulated as installed initially with basic operating system and a few applications by the manufacturers, and the user can select and install various applications for additional functions according to his or her tastes.

The applications can be developed by the user, or can be apps that other people, experts, or company developed for the smart phone (1100), which can be downloaded and stored or installed in the smart phone (1100) through tag, etc.

The area of services that can be provided by apps run on the smart phone (1100) can be related to the character and may include various genres such as download of arts, movie, etc., download of music in entertainment industry, fan club management for entertainers, pro-sports supporter activities, physical exercise including learning of dance or sports, etc., lecture, politician's propaganda, company's PR and ad, shopping, secretary function managing schedules, etc., and the service areas that the smart phone installed with apps are going to described in more detail below.

The wireless part (1110) accesses the character server (1300) with associated control signal, receives or downloads the character of 2D or 3D images generated from various forms of the registered famous person, and transmits and receives various data signal.

The wireless part (1110) includes functions of wireless access in short-distance communication methods including Bluetooth, Wi-Fi, Zigbee, NFC, etc., and can be provided through TAG.

Bluetooth provided in information devices including smart phone (mobile phone), notebook, PDA, digital camera, etc., and is a technology for wireless data communication within a range of about 10 meter, Wi-Fi is a technology for wireless communication through combining a wireless technology with High-Fidelity (Hi-Fi) of IEEE 802.11b High Rate standard, Zigbee is according to IEEE 802.15.4 standard for wireless networking in home or office with a range of 10-20 meters having low power consumption and low data rate, and NFC (Near Field Communication), a sort of electronic tag (RFID), is a technology for short-range wireless communication within about 10 cm using a frequency bandwidth of 13.56 MHz.

The smart phone control part (1120) monitors each part of the smart phone (1100), and outputs control signals for each.

The display part (1130) outputting multimedia signals according to control signals of the smart phone control part (1120) may include a video output part for outputting video signal and an audio output part for outputting audio signal, and the video output part may use a touch signal on the screen as an input means.

The display part (1130) may comprise an LCD or OLED.

The schedule part (1140) sets a schedule according to control signal of the smart phone control part (1120), and generates a specific alarm and informs the smart phone control part (1120) when it becomes the set time.

At that moment, the smart phone control part (1120) can output to the display part (1130) using the character that it is the time set by the schedule.

The conversion part (1150) may include a text part (1151) for converting audio signal to text signal, a speech part (1152) for converting audio signal to text signal, and a talk balloon (115) for converting text signal to an image of balloon containing the text to be displayed, according to the control signal of the smart phone control part (1120).

The talk-balloons, as in printed cartoon, animation, etc., have balloon shapes and letters, symbols, numbers representing talks, sounds, etc. of the character therein, and below they are described to contain talks, sounds, etc. of the character displayed in the display part (1130) of the smart phone (1100).

The character part (1160) may include an image storing part (1161) for storing original character that the smart phone (1100) downloaded from the character server (1300), the character decorated with accessories, the character image-processed through stimulation, and 2D or 3D images of other character, an accessory part (1162) for storing various 2D or 3D accessory images for decorating the character provided through download from the character server (1300), and an image-processing part (1163) for processing the 2D or 3D character so as to move according to the stimulation signals applied from outside, all controlled by a predetermined control signal of the smart phone control part (1120).

Here the stimulation signals may include touching, tickling, startling, strong or weak shaking, shocking (strong vibration), making sing, making dancing, etc.

The multimedia part (1170) may include an audio part (1171) for storing audio signal and outputting it to a predetermined level, a video part (1172) for storing video signal including picture, image, etc. and outputting them, and a text part (1173) for storing text signal including letter, symbol, number, etc. and outputting, all controlled by a predetermined control signal of the smart phone control part (1120).

The detection part (1180) may include a picture-taking part (1181) for inputting signal of taken picture, and a sensor part (1182) for detecting vibration, magnetic field, tilting, light intensity, etc. and outputting them, all controlled by a predetermined control signal of the smart phone control part (1120).

The keyboard part (1190) may input various command signals and data signals through monitoring and controlling by the smart phone control part (1120).

The communication network (1200) may include all kinds of communication network such as wire, wireless, data, Internet, etc.

The character server (1300) can register pictures for a fee or for free by request of the famous person who is the real person of the character, and image-process the registered pictures into character.

To input and store the famous person's characteristic pictures in the character server (1300) by request of registration and image-process and characterize them has merits of guaranteeing dignity of the famous person who owns the registered character and at the same time preventing infringement of rights of portrait in advance.

It has a merit of guaranteeing dignity of the famous person who owns the registered character and at the same time increasing the quality of management that the character server (1300) download the character to the smart phone (1100) through selective process upon fee.

The character server (1300) may include a character database part (1310), an accessory database part (1320), a contents database part (1330), a learning database part (1340), a fan group database part (1350), and a server operation control part (1360).

The character database part (1310) is for converting picture images of the famous person who requests to register according to predetermined procedure to character images and storing them, and the character images may further include 2D and 3D images, characters of face, top half, and whole body, normal, smiling, angry expressions, etc., and dancing, shaking, startling, singing actions, etc.

The accessory database part (1320) stores various kinds of 2D, 3D images of accessories for decorating the character.

The contents database part (1330) categorizes multimedia contents of real performance of the character person according to the famous people and stores in an assigned memory space, and according to an embodiment the contents may include multimedia contents of art activities such as song, issue of new song, performance, play, art, dance, gag, painting, magic, music, etc., sports activities such as golf, soccer, swimming, baseball, billiard, bowling, etc., and various kinds such as lecture, sermon, propaganda, PR, ad, record, etc., and they may be categorized by genre.

The learning database part (1340) may store multimedia information for experts for learning of education, heuristic, skills, etc. according to genre.

The fan group database part (1350) is for supporting on-line or off-line fandom group activities for communication with the character person, and the supports may include opening or accessing of sites for fan group on the Internet, management of members, collecting and delivering of fan letter, gift, etc., communicating among the members, etc.

The server operating control part (1360) is for monitoring and controlling operations of each parts of the character server (1300), and if the famous person requests to register it registers picture image of predetermined size, converts to a character, stores and manages them, provides the stored information through download for a fee or for free, and provides and manages information for fan group activities.

Below, a method for managing the character server (1300) is going to be described in detail out of managing methods of the famous people's character service system (1000) using smart phone, according to an embodiment.

If receiving a request of registration from a specific famous person (S110), the character server (1300) is provided with pictures through a specific procedure and stores them in the character database part (1310).

In an embodiment, the pictures include normal, smiling, angry, happy, painful expressions, etc., and can be for face, top half, and whole body.

The character database part finishes the registration by image-processing the pictures of various expressions provided by the famous person into characters following related controls of the server operating control part (1360) and storing them.

In another embodiment, when the famous person who wants registration provides a picture of a single expression only or a single picture of face, top half, or whole body, the character database part may guess and generate other expressions and other body parts through image-processing for guessing using the given picture according to control of the server operating control part. The image-processing for guessing other expressions or body parts using the given picture can be done by prior arts.

If the registration of the famous person's picture image is done, the character database part image-processes each of the picture images into a character (S120).

The server operating control part controls the accessory database part (1320) so as to generate various accessories for decorating the character according to the character's dimension and size and store them.

The contents database part (1330) collects, stores, and manages multimedia contents that a celebrity, the character person, performs, issues, or distributes through various paths according to related control signals of the server operating control part (S130).

If it is verified that the smart phone (1100) requests searching of specific character of favorite famous person through accessing of the communication network (1200) (S140), the server operating control part allows the access of the character database and searching of characters, so as to provide download for a fee or for free (S150).

The smart phone gets allowed in advance about accessing of the character server and searching of characters.

The server operating control part verifies receiving a request for organizing of fan club from the smart phone (S160).

If verified receiving the request for organizing the fan club from the smart phone, an Internet site of the fan club for the character person is generated, and the if the site is already there, the access to that site is allowed.

The smart phone allowed to access the fan club can send fan letters or gifts to the character person, and can exchange information with the other smart phones and collects information from the other smart phones (S170).

In an embodiment, if the smart phone sends a fan letter, the character server may print the fan letter or buy a gift, and then deliver them to the character person by mail, and in anther embodiment, the character person can deliver them to as assigned place.

Below, a method for managing the smart phone (1100) is going to be described in detail out of managing methods of the famous people's character service system (1000) using smart phone, according to an embodiment.

If verified that a command signal for searching of character is inputted (S210), the smart phone (1100) accesses the character server (1300) through the communication network, searches for character of the favorite famous person and accessories, downloads them, and stores them in an assigned memory space (S220).

Accessing the character server (1300) through the communication network, searching for character of the favorite famous person and accessories, and downloading them may be limited through predetermined procedures and fee or free.

The smart phone may decorate the character using the accessories downloaded and stored in the smart phone, store them for itself, and display them on a display (screen) (S230).

The smart phone (1100) monitors the detection part (1180) and the display part (1130) and verifies detecting and inputting of stimulation signals from outside (S240).

If detecting and inputting of the signal stimulating the character, it is verified where (location) and how much the stimulation signal was inputted or detected.

If the location and magnitude of the stimulation is verified, the smart phone controls the character part (1160), image-processes so that the character moves accordingly, and displays on the display (screen) (S250).

The character, responding to the stimulation, in an embodiment, may perform actions such as smiling, crying, grimacing, hurting, being startled, singing, shaking, dancing, sitting down, running, lying face down, or the like.

The character, if the magnitude of stimulation gets larger while responding, can control the magnitude of reaction still further, and in a predetermined time period, it can return to an original state.

The image-processing of such character's behaviors can be processed in 2D or 3D in the character part and displayed in the display part.

If verified that a control signal is inputted for changing the present menu or screen to a different one (S260), the smart phone performs image-processing the displayed character and reducing it to an icon of thumbnail image, and keeps to display the icon of thumbnail image on the newly changed menu (S270).

The thumbnail image means the an image of a certain size is reduced to a size of thumbnail, but of course the actual reduced size may be adjusted arbitrarily by the designer.

In an embodiment, the character that is reduced to a thumbnail size and displayed may be recovered to an original size and displayed if selected so by touching with a cursor or so.

If touching again the character that was recovered to the original size and displayed on the smart phone, in an embodiment, any one of the menu can be selected out of exchanging of emotion with the character, fan club activity, enjoying of the contents, learning, managing of schedule, etc.

Such menu may be managed by an app, application program, and they may be added or removed by installing or removing the apps.

If verified that a command signal is inputted for doing fan club activities by touching the displayed character (S280), the smart phone is connected to the character server, accesses a fan club associated with the displayed character, deliver a fan letter or gift, or exchanges news among the fan club members (S290).

The smart phone verifies whether a command signal to play contents by touching the displayed character is inputted or not (S300).

If the input of the command signal to play contents is verified, the smart phone accesses automatically the character server for searching all genre's contents including those that the character person created, collected through activities, or distributed and sets it to an search-enabled state.

The smart phone, by a related command signal from outside, downloads any one searched contents out of all genre's contents for a fee or for free and displays it (S310).

The played contents may be multimedia signals including video signals and audio signals.

The smart phone verifies whether a command signal of learning by touching the displayed character (S320).

If the input of the command signal of learning by the smart phone is verified, the smart phone accesses the character server automatically, searches various genre's stored contents for learning, selects any one contents for learning by a related command signal, and downloads the selected contents for learning for a fee or for free (S330).

The smart phone image-processes the downloaded contents for learning as if the displayed character teaches them, and plays the character and the contents for learning (S340).

Since the character of his or her favorite famous person teaches, the smart phone user can experience an increased effects of learning due to the improved liking about the subject, concentration of learning, etc.

The smart phone verifies whether a command signal for schedule management by touching the displayed character is inputted or not (S350).

If the input of the command signal for schedule management is verified, the smart phone checks the schedule of self-management, displays by the character, and outputs a specific alarming signal including video and audio by the character if it becomes the time set by schedule (S360).

Since the character of favorite person (the famous person) informs of the set schedule including detailed information such as, in an embodiment, content, object, place, person, time, etc., the smart phone user tends to keep more.

Below, explaining in detail referring to the drawings, the smart phone (1100) can use various area (genre)'s services through the app operated with the character.

The services possible on the smart phone with the displayed character and the app installed and operated thereon may include, for an embodiment, services for music download, movie and drama download, shopping, dance class, pro sports team supporters, company PR and ad, secretary, digital camera picture-taking with star character, politician activities, star character, etc.

In an embodiment, in a case of using a music download service, a menu for accessing the character server with the smart phone, selecting the character of star celebrity including favorite singer, actor, etc., and downloading them is displayed.

The user can select a list of new songs launched by the character person, and search and download a specific new song through selecting sub-menu such as listening in audio, watching in multimedia (video), etc.

If he/she wants to enjoy the song that the character person launched for free, the user can select a menu of free-listening, select sub-menu such as listening without saving, free listening with no limit, listening audio only, watching video only, etc., and search for free songs provided in the related sub-menu and enjoy them.

The song issued by the character person can be stored and managed by selecting sub-menu for storing in a virtual CD, storing in a character's virtual DVD, CD managing function, DVD managing function, etc., and a Karaoke service can be used if selecting a menu for a Karaoke function.

If selecting a menu for learning of song issued by the character person, the song-learning service can be used by selecting sub-menu for supporting lyrics, repeating a portion, recording and analyzing of user's singing, scoring, etc.

In another embodiment, if using an app operated with a movie-drama download menu, any one may be selected from menu for download of movie-drama by famous person service, preview, specific scene collection by actor, OST download, actor picture output, etc.

In still another embodiment, in a case of using an app for shopping menu, services such as today's recommendation item, hit item, low price item, etc. can be used by selecting corresponding sub-menu.

In an embodiment, in a case of using an app for character service menu, any one service can be used by selecting from menu for selecting a famous person of favorite genre, star marketing, caricature-3D-2D character-determining, PR and fan club management service, etc.

And, in a case of using an app for dance class service, any one service can be used by selecting from menu for star singer and dance, popular dance class, specific star character and dance, dance master and application, etc.

Dividing the dance class menu in more detail, any one of beginner, intermediate, and high level classes can be used by selecting the menu for dance class by levels.

A menu for dance learning enables the user to search for various kinds of dance classes and download a selected dance class, a menu for dance progress management enables the user to manage class hour, skill level, etc., and a menu for user dance recording and estimation enables the user to select any one menu from comparison, score announcement, dance battle, etc.

In the case of dance battle menu, services for recording dances of a user and a friend, checking the beat match, step match, etc., and scoring and analyzing, and if a repeat menu is selected a portion of dance clip from an assigned starting point to an assigned ending point can be played repeatedly.

Preferably, the learning (teaching) service combines the learning contents and the character, and image-processes and outputs them as if the character talks, acts, and teaches for him/herself.

If using the fan club service app, any one service can be selected and used from menu for informing activities of the famous person, newly-issued art including new song, new movie, and new drama, fan letter and utilizing of SNS, fan meeting, download for a fee or for free, associated commodity sale, PR activities, etc.

In a case of using a pro-sports supporters app, any one service may be selected and used from menu for game schedule informing, supporters activities, fan meeting, download for a fee or for free, associated commodity sale, PR, game download, game collection, virtual cheering, etc.

In a case of using a company PR and ad app, any one service may be selected and used from menu for club activities by commodity, Equus(R) club, BMW(R) club, iPhone(R) club, commodity PR and ad, commodity and service sale, etc.

In a case of using a secretary app, any one service may be selected and used from menu for secretary service by character, schedule, song and dance, etc.

In a case of selecting the song and dance menu, any one service may be selected and used from menu for limited free song and dance, using the song and dance for a schedule management and alarming.

In a case of using star character and digital camera shooting app, any one service may be selected and used from menu for picture-taking with star character, sticker picture taking, album making, photo combining, cheering banner, etc.

In a case of using a politician activity app, any one service may be selected and used from menu for political activity PR, election campaign, policy PR, political party PR, etc.

In a case of using a star character service app, a reaction menu can be selected, the user's stimulation such as voice, touch, ambient light, vibration, balance, etc. using all the sensors in the smart phone are detected, and they can be applied to make the character react.

If selecting a character application menu, voice, gesture, characteristics, etc. of the assigned famous person can be expressed with the selected character.

In the above, the present invention has been described in detail with specific embodiments, but various modification and changes within the spirit and scope of the invention are possible to people in the community of the arts, and such modifications and changes belong to the claims attached in this specification.

1. A system of servicing famous people's character, the system comprising:
a character server configured for storing picture images of famous people, image-processing the stored picture images to obtain characters representing various expressions, postures, and actions, storing and managing the characters according to each of the famous people;
a mobile communication device configured for accessing the character server through a wireless communication network and downloading the characters from the character server, applying a plurality of kinds of stimulation to one of the characters using input interface and control signals of the mobile communication device and image-processing the character such that the character is configured to react to the stimulation through multimedia comprising video, audio, and vibration, and using the characters reacting to the stimulation in performing a plurality of kinds of applications; and
a display provided in the mobile communication device and configured for displaying images and video of the characters and control menu of the mobile communication device,
wherein the character is image-processed by the mobile communication device into a diminished size and kept displayed on a corner of the display even when a screen is changed or a new menu is displayed.

2. The system of claim 1, wherein the character server is configured to have the famous people to register their own information including pictures, video, audio, and news according to predetermined procedures, and image-process the information of the registered famous people into characters of various images, and store-and-manage in a database.

3. The system of claim 1, wherein the character includes images for emotional expressions such as laughing, weeping, astonishing, and suffering, art activities such as singing, playing, performing, and dancing, sports activities such as golf, soccer, and swimming, and everyday life activities.

4. The system of claim 3, wherein the character is 2-dimensional, 3-dimensional, and in multimedia.

5. The system of claim 1, wherein if a character service menu is selected on the mobile communication device, the mobile communication device accesses the character server and searches, and if a specific famous person is selected and clicked, the mobile communication device downloads characters that are image-processed in various forms and actions from the character server.

6. The system of claim 5, wherein the mobile communication device downloads characters for a fee or for free.

7. The system of claim 1, wherein the stimulation comprises shaking, startling, tickling, making sing, and making dance.

8. The system of claim 1, wherein the applications comprise informing a user of the mobile communication device of a schedule of the famous people that is set by the assigned character person through the character server.

9. The system of claim 1, wherein the applications comprise sending fan letters and gifts to a character person, and performing activities related to a fan club or fandom group for the character person.

10. The system of claim 9, wherein the mobile communication device accesses the character server through the character displayed on the mobile communication device, searches for the activities of the character person, and downloads as or watch multimedia contents.

11. The system of claim 1, wherein the application comprises providing the user with contents in forms of multimedia including video, audio, and text, and the contents are produced directly or indirectly, uploaded to the character server by the character person, and include a plurality of genres including new song, favorite song, dance, performance, golf, soccer, swimming, and everyday life.

12. The system of claim 1, wherein the mobile communication device prepares clothes and accessories for the character, so as to decorate the character according to the user's control through the input interface of the mobile communication device.

13. The system of claim 12, wherein if the character talks or sings, a balloon with talk or song therein is displayed.

14. The system of claim 1, wherein the character server combines the selected character and a lesson contents, and image-processes and provides them as if the character teaches the lesson contents.

15. The system of claim 14, wherein the lesson contents is stored in the character server, and a selected lesson contents can be provided to the mobile communication device upon searching and selecting.

16. The system of claim 1, wherein the mobile communication device accesses the character server, watches in real-time the multimedia contents that the character person issued or is issuing presently, and searches and verifies news produced or collected around on for the character person.

17. The system of claim 16, wherein the character person includes a singer, a talent, an actor/actress, a sports star, an artist, an entrepreneur, a religious person, a politician, a composer, a novelist, a professor, a farmer, a fisherman, an engineer, a craftsman, an individual, and a legal person.

18. The system of claim 1, wherein the mobile communication device comprises a smart phone, a tablet PC, and an e-book reader.

19. A method for servicing famous people's character, the method comprising steps for:
accessing a character server, registering and uploading information, by a famous person;
image-processing the information to obtain characters of a plurality of expressions, postures, and actions for the famous person, that is, a character person, by the character server;
accessing the character server, searching characters for the famous person, and selecting and downloading the characters, by a mobile communication device; and
using the downloaded characters for a plurality of applications for the mobile communication device by the mobile communication device.

20. The method of claim 19, wherein the applications comprise alarming a schedule of a user, organizing and managing a fan club for the famous person, and combining the character with a multimedia learning contents.
